(19) United States
(12) Patent Application Publication
(10) Pub. No.: US 2019/0080352 A1
(43) Pub. Date: Mar. 14, 2019

(54) Segment Extension Based on Lookalike Selection

(71) Applicant: Adobe Systems Incorporated, San Jose, CA (US)

(72) Inventors: Kourosh Modarresi, Santa Clara, CA (US); Iulian Radu, San Jose, CA (US); Charles Menguy, New York, NY (US); Jisha Vadake Muthiyil, San Jose, CA (US); Yi Liu, San Jose, CA (US); Sheng Qiang, Stanford, CA (US); Aran Nayebi, Stanford, CA (US)

(21) Appl. No.: 15/700,343

(22) Filed: Sep. 11, 2017

(51) Int. Cl. G06Q 30/02; G06F 17/30; H04L 12/26; H04L 29/08

(52) U.S. Cl. CPC G06Q 30/0254; G06Q 30/0201; H04L 67/22; G06F 17/30539; H04L 43/08; G06Q 30/0253

(57) ABSTRACT

Systems and techniques are disclosed for creating segments of users that include baseline users having specified traits and users that are similar to the baseline users. A segment is created by identifying baseline users based on a segment rule that specifies one or more traits of the users to include. The data about the baseline and other users in the dataset is used to extend the segment. A representation of the segment is determined, for example, by determining average values of numeric traits and frequencies of non-numeric trait values of the baseline users in the segment. The representation of the segment is used to determine the similarity (i.e., similarity scores) of users to the segment and ultimately to determine which of the other users, who are not already included in the segment, should be included in the segment based the similarity of their traits to those of the segment representation.

### TECHNICAL FIELD

This disclosure relates generally to computer-implemented methods and systems and more particularly relates to improving the efficiency and effectiveness of computing systems used to create, analyze, and communicate with segments of users.

### BACKGROUND

Conventional analytics systems collect large volumes of user data and provide computer-based tools that allow analysts to selectively send electronic communications to particular groups of users. For example, an analyst may use such a tool to create a rule-based segment of users that only includes users whose age is known to be 20 years old. This segment is called a baseline segment, and the users in the segment are called baseline segment users. The analyst will then customize electronic content to those users, for example, by including content that is often of interest to 20-year-old users. Similarly, the analyst can customize the electronic content by providing the electronic communications on particular times or days and customizing the type of the communications as e-mails, texts, social media content, etc. based on the intended segment of users who will receive them.

The segmentation tools provided in conventional analytics systems have several limitations. Such tools create segments based on incomplete user data. For example, while there may be 100,000 users who are actually 20 years old, the user data may only have age data identifying the age of 75,000 of those 100,000 users. The age of the other 25,000 20-year-old users is identified in the data set as unknown. Thus, these 25,000 users will not be included in the segment and will not receive customized communications with the rest of the 20-year-old users. The segment is thus incomplete because of unknown data. In addition, a segment may also be incomplete from the analyst's perspective because the segment does not include similar users. For example, an analyst may wish to include other users in a segment that have the same interests, behaviors, or are otherwise responsive to receiving content customized for 20-year-old users, though these others users may not be 20 years old. The other users may either be close to that age or, in case of not being close to the age, have a similar behavioral tendency that is of interest to the analayst who created the original segment based on those behavioral patterns. Existing systems do not provide adequate tools for extending segments to include users that are left out of segments because of unknown data and/or users who should be included for practical purposes based on those users' similarity to segment users. In short, existing systems do not adequately identify “lookalike” users to include in segments.

### SUMMARY

Systems and techniques are disclosed herein for creating segments of users that include baseline users having particular traits and users that are similar to the baseline users. Embodiments of the invention create a segment by identifying baseline users to include in the segment based on a segment rule that specifies one or more traits of the users to be included in the segment. Identifying these baseline users involves identifying that the baseline users have the trait(s) in a user data set. For example, a segment rule may specify that the ages of users in the segment should be less 20 years old. The user data is analyzed to identify users that are known to be less than 20 years old and include them in the segment as the baseline users. The user data set also includes other user data for other users.

The data about the baseline users and other users in the dataset is used to extend the segment. A representation of the segment is determined, for example, by determining average values of traits of the baseline users. This representation is determined by evaluating multiple traits of the baseline users using the baseline user data in the user data set. The representation of the segment is used to determine the similarity (i.e., similarity scores) of users to the segment. Ultimately, this allows determining whether the other users, who are not already included in the baseline segment, should be included in the segment based the similarity of their traits to the segment representation. In one embodiment of the invention, the representation is also used to determine a similarity threshold and then used to determine similarity scores of other users that are compared with that similarity threshold. In this embodiment, the similarity threshold is determined by assessing how similar each of the baseline users is to the representation. Similarity scores of the baseline users are determined and averaged to provide the similarity threshold in this example. Embodiments of the invention identify a set of the other users to include in the segment based on the other user similarity scores and the similarity threshold. Where the threshold is based on the average of baseline user similarity scores, the other users that have similarity scores that are better than the threshold are determined to be at least as similar to the segment as the average baseline user who is already in the segment. Thus, the set of the other users are also included in the segment. The result is an extended segment that includes baseline users as well as lookalike users to whom electronic communications with customized electronic content can be sent.

These illustrative features are mentioned not to limit or define the disclosure, but to provide examples to aid understanding thereof. Additional techniques are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings.

FIG. 1 illustrates an exemplary computer network environment in which techniques for creating and communicating with segments of users according to embodiments of the invention can be implemented.

FIG. 2 illustrates a graphical depiction of creating a segment that includes baseline users and other users selected based on similarity to the segment.

FIG. 3 illustrates a flow chart illustrating an exemplary technique for sending electronic communications to a segment of users that includes baseline users and other users selected based on similarity.

FIG. 4 is a flow chart illustrating an exemplary technique for identifying other users to include in a segment based on similarity to the segment.

FIG. 5 is a flow chart illustrating an exemplary technique for determining similarity scores for users according to weighted user traits.

FIG. 6 is a block diagram depicting an example hardware implementation.

### DETAILED DESCRIPTION

As described above, conventional analytics systems do not adequately identify “lookalike” users to include in segments. Embodiments of the invention address these and other deficiencies of conventional systems by determining scores for other users (who are not already in a segment) that represent the similarity of the other users to the baseline users already in the segment. The other users are then evaluated based on the scores to determine which of the other users are “lookalike” users who should be added to the segment. The extended segments, including both baseline and lookalike users, can then be targeted with appropriate advertisements and other electronic communications.

Embodiments of the invention assess the similarity of users to a segment using a new metric that scores the users based on the similarity of the users to a representation of the segment. In one example, user data includes data about numerous traits of the users, such as, each user's name, age, browser type, income, etc. A centroid of all the baseline users in the segment is determined and this representation of the segment is used as a base of comparison with the other users. In one embodiment of the invention, a similarity score of each of the other users is determined by comparing the traits of each of the other users with the centroid representation. Scores for the baseline users in the segment are also determined and used to set a similarity threshold for extending the segment with the other users. For example, an average similarity score of the baseline users can be used as such a similarity threshold. In one embodiment of the invention, any of the other users having similarity scores that are better than the average score of the baseline users are considered “lookalikes” and are added to the segment. In this way, users that are sufficiently similar to a segment are added to the segment. A segment that includes 20-year-old users will be extended with other users that have features that are similar to the features of the baseline 20-year-old users in the segment.

The similarity scores that are used to assess a user's similarity to a segment are weighted to account for trait correlation and/or variation. In this way, similarity with respect to certain traits is more important to the similarity score than similarity with respect to certain other traits. For example, if the segment includes 20-year-old users, a father's age trait will be weighted higher than a height trait since there is a higher correlation between the user's age and the user's father's age than there is between the user's age and the user's height.

The similarity scores are based on a representation of the segment that takes into account how consistent the baseline users in the segment are with one another. The greater the diversity in the segment the greater individual users in the segment will differ from one another and the representation of the segment. Accordingly, the similarity scores represent the consistency within the segment itself and thus can be considered self consistency scores (SCSs). Given a set of users in a segment, SCSs can be used to determine how consistent the users are with one another with respect to the users' traits. Thus, the scoring techniques of embodiments of the invention are also used evaluate the accuracy of other segment extension techniques. For example, a random forest-based classification technique may be used to identify user classes that are then used to identify users to add to a segment. Self consistency scores of these added users can be determined and provide a basis for assessing the random-forest-based technique with respect to how consistent users identified by the technique are with one another with respect to relevant/weighted traits. Thus, in addition to providing a technique for identifying lookalike users for a segment, embodiments of the invention evaluate the accuracy of other such techniques using SCSs as accuracy metrics.

### Terminology

As used herein, the phrase “computing device” refers to any electronic component, machine, equipment, or system that can be instructed to carry out operations. Computing devices will typically, but not necessarily, include a processor that is communicatively coupled to a memory and that executes computer-executable program code and/or accesses information stored in memory or other storage. Examples of computing devices include, but are not limited to, desktop computers, laptop computers, server computers, tablets, telephones, mobile telephones, televisions, portable data assistant (PDA), e-readers, portable game units, smart watches, etc.

As used herein, the phrase “segment” refers to a set of users or user data defined by one or more rules. A segment's “rule” is any criteria that can be used to identify which user are included in the segment. For example, a first rule for a first segment can identify all users who have made at least two online purchases, a second rule for a second segment can identify all users who are platinum reward club members, and a third rule for a third segment can identify all users who are less than 20 years old.

As used herein, the phrase “user” refers to any customer or other person who uses or who may someday use an electronic device such as a computer, tablet, or cell phone to execute a web browser, use a search engine, use a social media application, access an e-mail application, or otherwise use the electronic device to access electronic content via an electronic network such as the Internet. Accordingly, the phrase “user” includes customers and any other person that data is collected about via electronic devices, in-store interactions, and any other electronic and real world sources. Some, but not necessarily all, users access and interact with electronic content received through electronic networks such as the Internet. Some, but not necessarily all, users access and interact with online ads received through electronic networks such as the Internet. Marketers and other analysts send some customers and other users online ads to advertise products and services using electronic networks such as the Internet.

As used herein, the phrase “baseline user” refers to any user who is included in a segment based on the segment's rule(s) applied to information known about the users in a user data set. For example, if the segment's rule identifies all users whose age is less than 20 then all users whose age in the user data set is identified as less than 20 are the baseline users.

As used herein, the phrase “trait” refers to any numeric or non-numeric feature of a user. Traits relate to metrics and categorical features. Metrics provide numeric information about a user including, but not limited to, age, income, number of televisions, click-through rate, view-through rate, number of videos watched, conversion rate, revenue, revenue per thousand impressions (“RPM”), where revenue refers to any metric of interest that is trackable, e.g., measured in dollars, clicks, number of accounts opened and so on. Generally, metrics provide a numerical order, e.g., one revenue value is greater than another revenue value which is greater than a third revenue value and so on.

Categorical features provide an item of information about a customer that is not numerically ordered. Dimension elements are one example of a categorical feature. For example, for a “residence city” dimension, the elements of the residence city dimension can take on numerous values, e.g., “New York,” “San Jose,” etc. Each of these dimension elements, i.e., each residence city, is a categorical feature. Users either have, or do not have, each categorical feature. For example, if the categorical feature is that residence city is “New York”, the residence city of a given user is either New York or it is not New York. If the residence city of the customer is New York, the user has that categorical feature. If not, the user does not have that categorical feature. Within a segment of user, a percentage of the users having a categorical feature can be determined. For example, if 40% of users in a segment are from New York, the percentage of users in the segment having the categorical feature is 40%. Categorical features can thus be determined from dimensions where dimensions are non-numerically-ordered information about one or more customers. Examples of dimensions include page name, page uniform resource locator (URL), site section, product name, and so on. Dimensions are generally not ordered and can have any number of unique dimension elements. For example, the dimension “country” can take values “USA”, “India”, “China”, “Mexico”, and so on. Dimensions can often have matching values for different users. For example, a state dimension can have the dimension element “California” for many users. In some instances, dimensions have multiple values for each user.

As used herein, the phrase “representation” refers to values and/or other information that represent average or typical traits or trait frequency of the baseline users of a segment. A representation of a segment can identify average numerical values and/or information based on the distribution of dimension values for multiple traits. For example, the representation of a segment can identify that the average income of baseline users in the segment is $60,000 and that 10% of the baseline users in the segment are from California. The representation can represent all or only a subset of the user traits for which user information is available in a data set.

As used herein, the phrase “data set” refers to one more file, server, database, or other storage mediums that store information about a group of users.

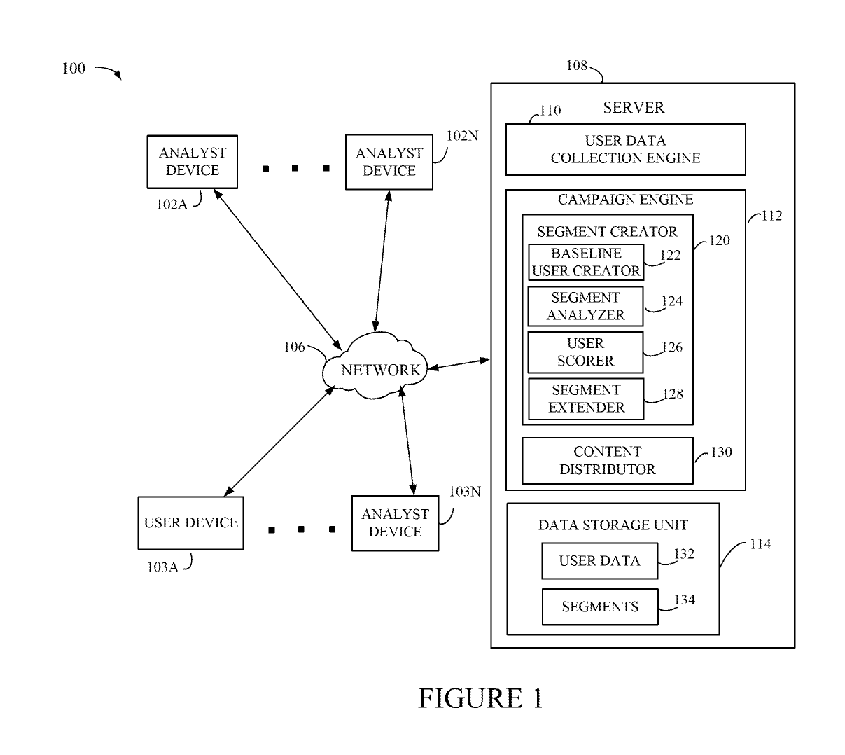

FIG. 1 is a diagram of an environment 100 in which one or more embodiments of the present disclosure can be practiced. The environment 100 includes one or more analyst devices, such as analyst device 102A up to analyst device 102N and one or more user devices, such as user device 103A up to user device 103N. Each of the analyst devices and the user devices is connected to a server 108 via a network 106. Analysts, such as marketers and other people who send electronic content to users, access the server 108 to provide electronic content based on user data 132 about the users of user devices 103A-N. Such user data 132 is collected directly and indirectly from the users during their use of user devices 103A-N and/or from other user information sources. For example, information may be compiled from user-provided information in user profiles associated with various accounts, user interactions with user interfaces provided on web pages and applications, user in-store shopping behavior, and many other sources.

An analyst using one of the analyst devices 102A-N to access the server 108 can create segments of the users for various purposes. In one example, the analyst creates a marketing campaign targeting a segment of users with advertisements for a new credit card offering with particular benefits for new college grads. The analyst creates a segment of users (e.g., of users whose age is known to be 20 in the user data 132) and sends electronic content with the advertisements to those users. The server 108 can be configured with various engines to facilitate creating and using such segments.

The server 108 includes a user data collection engine 110 that is configured to receive user data and compile that user data in a data storage unit 114 as user data 132. User data 132 can be collected and kept separate for a single analyst or company (e.g., keeping company A's customers' data separate from company B's customers' data) or can be combined for use by multiple analysts and/or companies. In one embodiment of the invention, an analyst configures the user data collection engine 110 to collect data about particular user traits and/or from particular sources. For example, analyst may use the user data collection engine 110 to configure a web page for analytics tracking and compile user information based user interactions with the webpage.

The server 108 additionally includes a campaign engine 112 configured to create segments of users and/or distribute electronic content to those users. The campaign engine 112 includes a segment creator 120 and a content distributor 130. The segment creator 120 is a module comprising executable code or other computer-readable instructions that perform various automated and/or semi-automated operations to create segments. In this example, the segment creator 120 includes several sub-modules, including a baseline user creator 122, a segment analyzer 124, a user scorer 126, and a segment extender 128. The baseline user creator 122 is configured to identify baseline users to include in a segment based on a segment rule that specifies one or more traits of the users who will be included in the segment. Identifying these baseline users involves identifying that the baseline users have the trait(s) based on baseline user data in the user data 132. For example, a segment rule may specify that the ages of users in the segment should be less 20 years old and that the income of users in the segment should be less than $20,000 per year. The user data is analyzed to identify users that are known to be less than 20 years old and whose income is known to be less than $20,000 and include those users in the segment as the baseline users.

The segment analyzer 124 is configured to analyze a segment to determine a representation of the segment. Such a representation provides values and/or other information that represents average or typical traits or trait frequency of the baseline users of the segment. A representation of a segment can identify average numerical values and/or information based on the distribution of dimension values for multiple traits. In one embodiment of the invention, the segment analyzer 124 determines a representation of a segment by determining average values of numeric traits and occurrence frequencies of non-numeric trait values. For example, the representation of a segment can identify that the average income of baseline users in the segment is $60,000 and that 10% of the baseline users in the segment are from California. This representation is determined by evaluating multiple traits of the baseline users using the baseline user data in the user data set.

The user scorer 126 is configured to use the representation of the segment provided by the segment analyzer to score users. The user scorer 126 provides similarity scores that quantify how similar a given user is to the segment, i.e., how similar such a user is to the representation of the segment. The scores provided by the user scorer 126 are ultimately used to determine whether the other users, who are not already included in the segment, should be included in the segment based on the similarity of their traits to the representative traits of the segment representation. In one embodiment, the user scorer 126 determines similarity scores of each of the baseline users to the representation of the segment and averages (or otherwise uses) those similarity score to determiner a similarity threshold. The user scorer 126 then determines similarity scores for the other users to allow the relative similarity of other users to the segment to be compared.

The segment extender 128 determines which of the other users, who are not already included in the segment, should be included in the segment based on the similarity scores and the similarity threshold. All users whose similarity scores indicate that the users are sufficiently similar to the segment are considered to be “lookalike” users and are added to the segment. The segment is thus extended to include both users who satisfy the segment rule (i.e., the baseline users) and additional users who have similar traits to the typical/representative baseline users (i.e., the lookalike users that have similarity scores satisfying the similarity threshold).

Server 108 can be implemented using one or more servers, one or more platforms with corresponding application programming interfaces, cloud infrastructure and the like. In addition, each engine can also be implemented using one or more servers, one or more platforms with corresponding application programming interfaces, cloud infrastructure and the like.

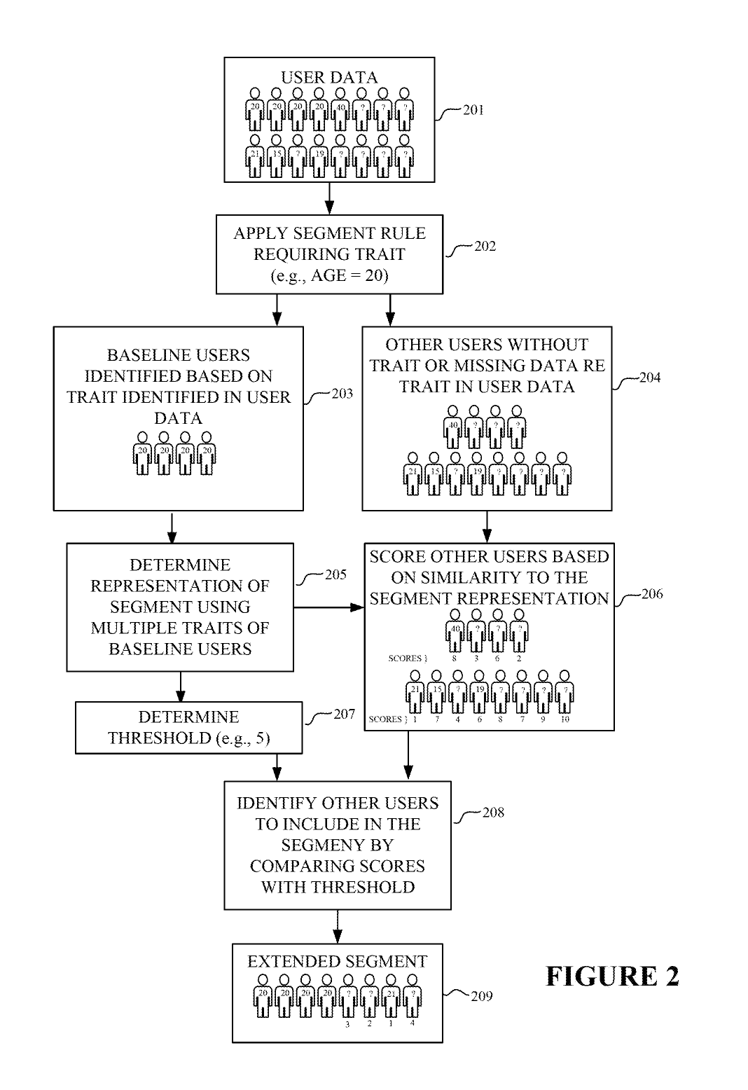

FIG. 2 illustrates a graphical depiction of the creation of a segment that includes baseline users and other users selected based on similarity to the segment. In this example, block 201 includes user data about a group of users including data about at least some of the traits of some of the users. Block 202 illustrates applying a segment rule requiring a particular trait to the user data 201. In this example, the segment rule requires that the user's age be 20. Applying the segment rule of block 202 results in baseline users 203 being identified based on the trait being in the user data for those users. The other user 204 from the user data 201 are identified users without the trait or who are missing data regarding the trait in the user data, i.e., the age of the users is unknown.

Block 205 determines a representation of the segment using multiple traits of the baseline users and, in block 206, this representation of the segment is used to determine a similarity threshold, which is “5” in this example. The representation of the segment is also used in block 205 to score the other users 204 by comparing traits of the other users to the representation of the segment. In block 208, some of the other users are identified to be included in the segment by comparing the scores of the other users with the similarity threshold. For example, other users having similarity scores below the “5” threshold, e.g., similarity scores of 1, 2, 3, or 4, are included in the segment and other users with higher similarity scores are not included. In another example, similarity scores are normalized to [0, 1], with 1 being the highest similarity score. The higher the score is, the higher the similarity is between two users (or any other objects). In implementations in which greater similarity scores represent less similarity, users having similarity scores that are less than the similarity threshold are selected. In implementations in which greater similarity scores represent greater similarity, users having similarity scores that are more than the similarity threshold are selected. The result is an extended segment 209 that includes the baseline users from block 203 as well as a set of the other users identified in block 208. Note the other users who are identified in block 208 and added to the segment can have ages that differ from 20 or that are unknown. Accordingly, in this example, the segment is extended with users who do not strictly conform (e.g., age 21) with a segment's rule as well as will users whose conformity to the segment rule is unknown (e.g., age unknown). Embodiments of the invention can be customized to include one or both of these classes of other users depending upon the circumstances and/or analyst preferences.

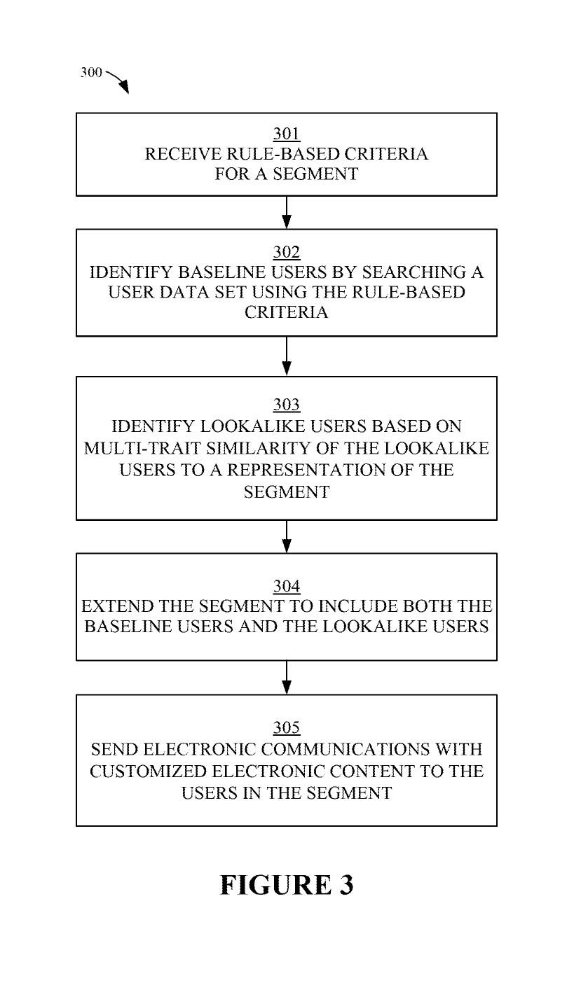

FIG. 3 illustrates a flow chart illustrating an exemplary technique 300 for sending electronic communications to a segment of users that includes baseline users and other users selected based on similarity. The exemplary technique 300 is described in the context of implementation via one or more modules, such as by the segment creator 120 and content distributor 130 of FIG. 1, although other devices and configurations can also be used to implement the technique 300. The exemplary technique 300 can be implemented by storing and executing instructions in a non-transitory computer-readable medium. Reference to the technique 300 being performed by a computing device includes the technique 300 being performed by one or more computing devices.

The technique 300 involves receiving rule-based criteria for a segment, as illustrated in block 301. For example, a user interface of the segment creator 120 may provide a list of user traits and receive input selecting one or more of the traits and specifying values or value ranges for those traits. For example, the segment may be specified by a rule that identifies users residing in California and users with incomes over $50,000 per year. In another example, input specifying rule-based segment criteria is received from an analyst. Such input can select a previously-used segment or previously-used segment criteria. In another example, the segment criteria is accessed from an external source such as a repository that provides content for analysts who work in a particular industry or having particular interests.

The technique 300 identifies baseline users by searching a user data set using the rule based criteria, as shown in block 302. For example, the segment creator 120 may send database queries or other information request messages that identify particular traits and specify values for those traits to request search results that identify users having the specified traits.

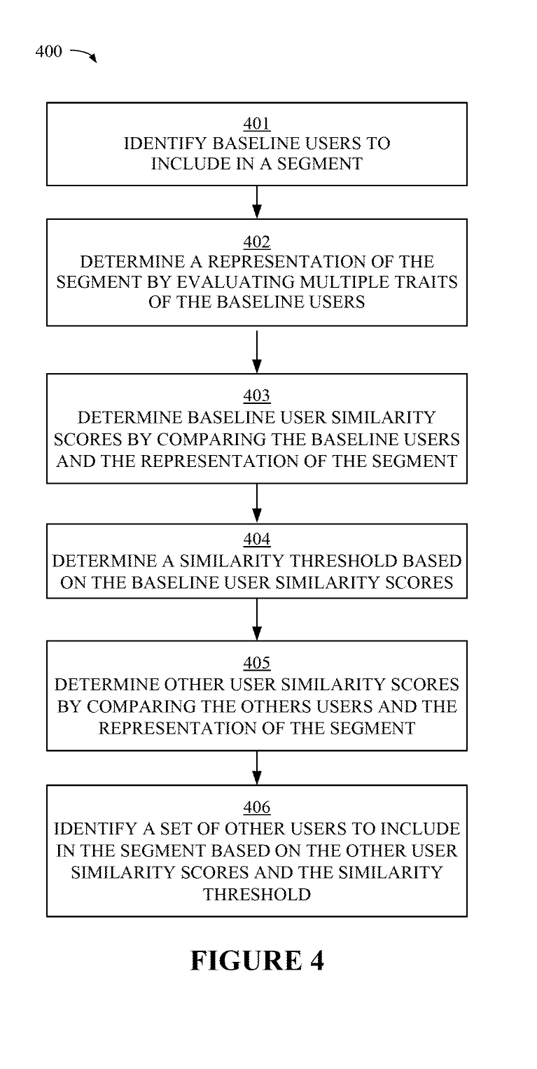

The technique 300 identifies lookalike users based on multi-trait similarity of the lookalike users to a representation of the segment, as shown in block 303. An exemplary technique for identifying such lookalike users is discussed herein with respect to FIG. 4. Using such a technique users are identified that are appropriate to add to the segment even though the users' traits specified by the segment criteria are unknown or different from the criteria. However, the added users are similar to the baseline users in the segment with respect to other traits. For example, if a segment includes users of age 20, the average father's age of the baseline users in the segment may be 44. The representation of the segment will reflect this and other users whose father's age is also 44 or near 44 will be similar to the representation of the segment with respect to this trait. The more trait similarities to the representation a user has, the better the similarity score of the user. A user having many similarities to the representation of the segment will have a similarity score that reflects these similarities and will be included in the segment as a lookalike user. Accordingly, the technique 300 further involves extending the segment to include both the baseline users and the lookalike users, as shown in block 304.

Finally, the technique 300 involves sending electronic communications with customized electronic content to the users in the segment as shown in block 305. In one embodiment, the content distributor 130 provides a user interface configured to receive input that identifies a segment (including baseline and extended users), one or more items of electronic content to distribute to users in the segment, and/or input specifying distribution parameters for distributing the electronic content to the users, e.g., format, days/times for distribution, interaction tracking parameters, etc.

FIG. 4 is a flow chart illustrating an exemplary technique for identifying other users to include in a segment based on similarity to the segment. The exemplary technique 400 is described in the context of implementation via one or more modules, such as by the segment creator 120 of FIG. 1, although other devices and configurations can also be used to implement the technique 400. The exemplary technique 400 can be implemented by storing and executing instructions in a non-transitory computer-readable medium. Reference to the technique 400 being performed by a computing device includes the technique 400 being performed by one or more computing devices.

The technique 400 involves identifying baseline users to include in a segment, as shown in block 401. This process can be performed using the procedures described with respect to block 302 and elsewhere in this disclosure.

The technique 400 further involves determining a representation of the segment by evaluating multiple traits of the baseline users, as illustrated in block 402. Various techniques can be used to implement block 402. In one embodiment of the invention, the representation of the segment is a centroid that represents the center of many or all of the traits of the baseline users of the segment. For binary traits, the similarity score is determined using jaccard similarity. For example, if u(1)=[1, 0, 0, 0, 1, 1] and u(2)=[0, 0, 0, 1, 1, 1] reflecting the values of these users on each of six traits, then the Jaccard similarity of these two users, user (1) and user (2), is 2/(2+2)=1/2. For categorical traits, we first convert the categorical traits to binary traits using dummy variables, and then use Jaccard similarity to compute similarities. For example, if u(1)=[female, employed] and u(2)=[male, unemployed], then using dummy (binary) variables, these categorical traits are converted to u(1)=[1, 1] and u(2)=[0, 0]. Thus, their Jaccard similarity is zero. For numerical traits, first norms and/or second norms can be used. A first norm is used when less sensitivity to outliers and more robustness are needed. A second norm (i.e., a Euclidean norm) is used when more weight needs to be given to outliers. In another example, the trait data is represented as a vector. Any user's traits can be represented as a vector. For example, users 1 and 2 can be represented as u(1)=[2, 4, 6] and u(2)=[3, 2, 4], where these vectors represent three traits of each user. For example, these three traits can be a number of clicks on a specific webpage, an amount of time spent (e.g., in minutes) on a web page, and an amount of money spent (e.g., in dollars) using the links on the webpage. The average (or center) representing these two users in this example, is [2.5, 3, 5].

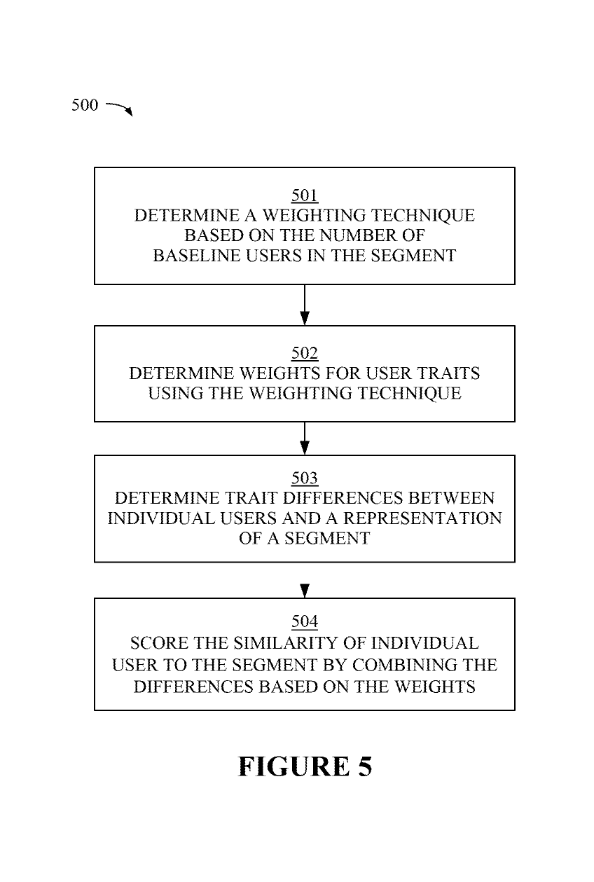

The technique 400 further involves determining baseline user similarity scores by comparing the baseline users and the representation of the segment, as shown in block 403. Consider an example in which there are four traits for the users in a data set: age, income, age of father, and age of mother. In this example, the representation of the segment is a centroid, that represents that averages of all the known values of the baseline users in the segment. For example, centroid values of the representation may be: age=20, income=$22,500, age of father=44, and age of mother=42. The similarity score for a user can then be determined by comparing the user with the centroid. For example, a user's similarity score can be determined by summing the differences D1, D2, D3, D4 for the four traits respectively. The differences can then be normalized and/or weighted, as discussed further with respect to FIG. 5. For example, if the user's age is 22, D1 is 2, which is the result of 22−20. In one embodiment of the invention a similarity score is determined by determining the difference relative to each trait Dt=|Vrt−Vt|Vrt, for trait “t” where Vt is the value for trait “t” for the user and Vrt is the value of the trait in the representation of the segment. In the above example, D1 is |20−22|/20=0.1. The differences of all the traits are used to determine a similarity score, for example, using the formula Si=D1+D2+D3+D4, etc. If user data is not available for one or more of the traits for the user i, then the score can be adjusted accordingly. For example, the score can be divided by the total number of traits for which information is available, so that user scores relative to one another will be penalized for lacking data. In an example, when determining the similarity scores, missing data is accounted for by computing the missing data and using the results to compute the similarities. Thus, the similarities are computed from data for each trait. Models that can compute missing data include singular value decomposition (SVD)-based models, Random Forest models, and Regression models.

The technique 400 further involves determining a similarity threshold based on the baseline user similarity scores, as shown in block 404. In one embodiment of the invention, the similarity threshold is determined by averaging the similarity scores of the baseline users. Other techniques can be used to determine the similarity threshold. The similarity threshold can be set, for example, so a user joins the baseline segment if the user has a similarity at least equal to the lowest mutual similarity of any user in the baseline to the baseline centroid. In another example, the similarity threshold is set so that a user joins the baseline segment if the user has a similarity at least equal to a threshold of 90% or higher of an average similarity. In another example, a threshold percentage other than 90% can be used. The threshold percentage parameter can be determined by analysts and can be based on a specific application, a metric, other features of the targeting segment, or a combination thereof.

The technique 400 further involves determining other user similarity scores by comparing the other users and the representation of the segment, as shown in block 405. Such determinations can be performed using the techniques discussed above with respect to block 403. Next, the technique 400 identifies a set of other users to include in the segment based on the other user similarity scores and the similarity threshold, as shown in block 406. In one embodiment of the invention, this involves comparing the similarity scores with the similarity threshold and selecting the other users having scores that are greater than or less than the similarity threshold. In implementations in which greater similarity scores represent less similarity, users having similarity scores that are less than the similarity threshold are selected. In implementations in which greater similarity scores represent greater similarity, users having similarity scores that are more than the similarity threshold are selected.

FIG. 5 is a flow chart illustrating an exemplary technique 500 for determining similarity scores for users according to weighted user traits. The exemplary technique 500 is described in the context of implementation via one or more modules, such as by the segment creator 120 of FIG. 1, although other devices and configurations can also be used to implement the technique 500. The exemplary technique 500 can be implemented by storing and executing instructions in a non-transitory computer-readable medium. Reference to the technique 500 being performed by a computing device includes the technique 400 being performed by one or more computing devices.

The technique 500 involves determining a weighting technique based on the number of users in the segment, as shown in block 501. For example, this can involve selecting whether a supervised or unsupervised techniques will be used to determine the weights. A supervised technique can involve identifying correlations between traits and the metric, e.g., determining relationships with a segment rule trait such as age with the rest of the traits: income, father's age, mother's age. The correlations are normalized to provide a respective weight for each of the traits. As an example, linear regression can be used, where the segment rule trait is the output (or predicted value) and all other traits are the inputs or predictors. The normalized coefficients of each trait in the regression model will determine a weight (or significace) of the trait. The weight of the trait is used as a corresponding weight when computing similarities. An unsupervised approach can use, for example, a single value decomposition to determine a new feature that expresses the variation of the user data. Such a new variable is constructed to have principle components that provide coefficients that provide a weight for each of the traits. More specifically, a principal component is used where a constraint will be added, so each principal component has only one non-zero coefficient. The non-zero coefficient corresponds to a specific trait. The amount of variation the precipice component represents (as a fraction of the total variation of the original data) determines the weight of the trait. Whether to use a supervised or unsupervised weighting technique depends on number of baseline users in segment. If there are enough baseline users (e.g., above a threshold number of users) to allow an accurate computation of correlation of segment-rule traits with the rest of the traits, then a supervised weighting approach is used. However, if the number of baseline users is smaller, the unsupervised weighting approach is used.

The technique 500 determines the weights for the user traits using the weighting approach, as shown in block 502. The similarity score is computed using a weighted similarity of each of the traits (i.e., corresponding trait differences or similarities). The weights can be computed using methods such as supervised or unsupervised techniques, as explained herein.

The technique 500 next determines trait differences between the individual users and a representation of a segment, as shown in block 502. For numeric traits, this involves determining a numeric difference and possibly normalizing the difference. For categorical traits, this involves determining the difference using another technique, such as by determining a jaccard difference as discussed above.

The technique 500 scores the similarity of the user to the segment by combining the differences based on the weights, as shown in block 504. In one embodiment of the invention, a similarity score is determined using the formula Si=W1*D1+W2*D2+W3*D3+W4*D4, etc., wherein Wt is the weight determined for trait “t”. If user data is not available for one or more of the traits for the user “i”, then the score can be adjusted accordingly as discussed above with respect to FIG. 4.

In the example of FIG. 5, the weights used to determine the similarity score are determined based on correlation or variation. Determining weights in this way is advantageous over determining weights based on frequency because doing so better represents the relevant relationships between the traits.

Embodiments of the invention, among other advantages, provide a new and advantageous way of scoring user-to-segment similarity that is based on comparing user traits to average/centroid traits of users within the baseline and selecting users to be added to segment when the users' scores are better. And, in addition, embodiments of the invention provide techniques for weighting trait differences using weights that are based on correlation/variation and enable more meaningful comparison of user similarity to a segment.

### Evaluating Segment Extension Models

Embodiments of the invention provide a new metric that is useful for determining the consistency of user data within a segment and thus can be used to assess how accurately segment extensions techniques are with respect to extending segments with similar users. The metric can be used as a validation of the accuracy of an extension technique after the technique is applied to extend a segment. The following provides an example of techniques that can be assessed and/or validated using the new metric.

A first technique is referred to as a trait weight model. This model performs the following algorithm. First, for the base segment/trait of the algo model that is going to be ex-panded, calculate: (a) Traits[]−unique traits accessible to the model except the traits in the baseline; (b) Nin−total number of unique baseline users; and (c) Nall−total number of unique users accessible to the model (users that are members of at least one trait in Traits[]). Second, for each trait in Traits[] calculate: (a) nin−total number of users that are members of both the baseline and the trait; (b) nall−total number of users that are members of the trait; (c) TF=(nin/Nin)/(nall/Nall)−term frequency; (d) IDF=log(Nall/nall)−document frequency; (e) Sc=TF*IDF; and (f) Wi=Sc/Sum(Sc)−weight (only pick at most 1000 traits). Third, for each user outside our segment assign: (a) Trait existence: ti=[0,1 ]; and (b) Score: Us=Sum(Wi2*ti). This model can be treated as a variant of the actual TF/IDF score as the ‘TF’ calculation in the traitweight algorithm is different from the classical TF/IDF model. TF is calculated as:

$$\frac{( \frac{{n}_{in}}{{N}_{in}} )}{( \frac{{n}_{all}}{{N}_{all}} )}$$

In the classical TF/IDF model, the TF term would be:

$$( \frac{{n}_{in}}{{N}_{in}} )$$

This deviation from the actual TF logic calls for further validation of the traitweight scores.

Additional techniques are based on a classification approach. In the classification approach, the baseline is treated as the label and models are built to identify the most likely users to be included in the target audience. Logistic regression and random forest are two such methods. Logistic regression is a classification approach in which we can calculate the P (X|Y) directly using the sigmoid or logit function. The logic function applied to a linear function of the data can be represented as P(X=1|Y, W). Logistic regression provides outputs as probabilities, which makes it easier to rank that outcomes. It also has lesser variance compared to other models making it a more reliable option. Results are more inter-pretable, and gives information on which features have more predictive power. One implementation uses the skicit-learn's Logistic Regression classifier. Data is taken based on an equal number of users from the baseline and an equal number of random users from the population, labelling them 1 and 0 respectively. For new use rs, this trained model is used to get the probability of them being in the baseline segment. Based on observation, population users are mostly (when comparing the users with SCS similarity score of higher than threshold to the total users of the population) with low SCS scores, so many of them have label 0. Though, to prevent mislabeling, this labeling process is used iteratively, by using the model to predict the label of the users originally labeled as 0, until the labels do not change (for almost all labels; in this example, we set that as a relative error of 5% or less).

A random forest is a parallelized tool configured to perform classification. The random forest can be similar to a logistic regression. Random forest can be used to provide the similarity score for a user. Given a file containing UserIDs and their corresponding TraitIDs, the baseline segment is constructed by picking a random trait, and labeling each unique user with a 1 if they have the trait or 0 if they do not. Furthermore, every unique user is represented by a binary vector of length, number of traits 1, which includes the presence or absence of any of the traits other than the random trait that was previously chosen. The function create dataset ( ) does this. It first calls the function preprocess data ( ) which maps UserIDs to their associated traits, and then randomly chooses a trait for the labels. Finally, it creates the binary vectors using the map. These functions rely on Python's implicit set ( ) operations to efficiently remove duplicates. Finally, the function fit rf( ) fits the Scikit-Learn Random Forest classifier to the data, which is parallelized for efficiency (using the parameter n jobs=−1) and the class weights are set to balanced, which means the class weights are inversely proportional to the number of 1 and 0 labels in the dataset (to deal with the issue that there will likely be far more 0 labels than 1 labels in the dataset). The Random Forest will rank the TraitIDs by their Gini impurity, and this is printed in increasing order. Moreover, a dictionary mapping UserIDs to their non-normalized similarity scores is returned, where the non-normalized similarity score is the sum of the Gini impurities of the features that the user has. This is implemented in the code as a dot product between a user's binary feature vector and a feature importance vector returned by the Random Forest classifier. The random forest algorithm returns the similarity scores while predicting the probability each user is in the baseline segment.

In addition, TF/IDF based segment extension technique can be considered. TF/IDF is a weighting system used in text mining to evaluate how important a word is to a document in a collection or corpus. The importance increases proportionally to the number of times a word appears in the document but is offset by the frequency of the word in the corpus. An algorithm like the TF/IDF weighting can be used for segment extension, where traits are considered as topics and users are treated as documents.

Another technique involves a true discovery rate method. The true discovery rate method attempts to find the probability of any given trait being the differentiating trait for baseline segment from the rest of the population. The higher the true discovery rate, the more confidence there is that the trait is a differentiating trait that separates the population. This is considered to be a good trait weight since the sum of the weighted trait gives a probabilistic expectation score on whether those people should be in the segments or not. Those with the highest score are the most like the baseline population. The true discovery rate concerns itself with first computing the z-values. The True Discovery Rate are then computed using the true discovery rate computation.

A clustering-based approaches can also be used. In the clustering-based approach, the baseline segment is treated as one cluster and the rest of the population as another cluster. There are several approaches to apply this cluster information to find similar users from the population. One of the approaches is to find the distance of all users in the population to the baseline cluster centroid and then rank them according to the distance. Another approach is to rank them based on their relative distance (Jaccard) to the center of the baseline segment vs to the center of the population. The first approach is referred to as the cluster1 model and the second as the cluster2 model.

The above models and other techniques for segment expansion can be tested using the metrics and techniques disclosed herein. This metric is referred to as Self Consistent Similarity (SCS). Ideally, most of the baseline users should have a high SCS similarity score. In general, for different types of data sets, different metrics are used to compute the similarities amongst users (such as maximum absolute estimate (Manhattan distance), Euclidean distance, Jaccard similarity, . . . ). In one embodiment of the invention, the Jaccard distance metric is used to compute similarities.

### Exemplary Computing Environment

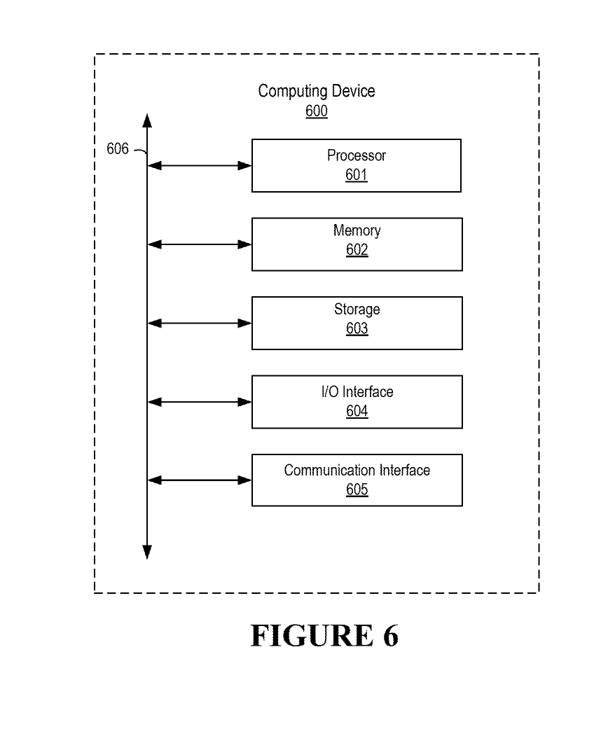

Any suitable computing system or group of computing systems can be used to implement the techniques and methods disclosed herein. For example, FIG. 6 is a block diagram depicting examples of implementations of such components. The computing device 600 can include a processor 601 that is communicatively coupled to a memory 602 and that executes computer-executable program code and/or accesses information stored in memory 602 or storage 603. The processor 601 may comprise a microprocessor, an application-specific integrated circuit (“ASIC”), a state machine, or other processing device. The processor 601 can include one processing device or more than one processing device. Such a processor can include, or may be in communication with, a computer-readable medium storing instructions that, when executed by the processor 601, cause the processor to perform the operations described herein.

The memory 602 and storage 603 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 600 may also have a number of external or internal devices, such as input or output devices. For example, the computing device is shown with an input/output (“I/O”) interface 604 that can receive input from input devices or provide output to output devices. A communication interface 605 may also be included in the computing device 600 and can include any device or group of devices suitable for establishing a wired or wireless data connection to one or more data networks. Non-limiting examples of the communication interface 605 include an Ethernet network adapter, a modem, and/or the like. The computing device 600 can transmit messages as electronic or optical signals via the communication interface 605. A bus 606 can also be included to communicatively couple one or more components of the computing device 600.

The computing device 600 can execute program code that configures the processor 601 to perform one or more of the operations described above. The program code can include one or more modules. The program code may be resident in the memory 602, storage 603, or any suitable computer-readable medium and may be executed by the processor 601 or any other suitable processor. In some techniques, modules can be resident in the memory 602. In additional or alternative techniques, one or more modules can be resident in a memory that is accessible via a data network, such as a memory accessible to a cloud service.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure the claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more techniques of the present subject matter. Any suitable programming, scripting, or other type of language or combinations of languages may be used to implement the teachings contained herein in software to be used in programming or configuring a computing device.

Techniques of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific techniques thereof, it will be appreciated that those skilled in the art, upon attaining an understanding of the foregoing, may readily produce alterations to, variations of, and equivalents to such techniques. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method, performed by a computing device, for creating segments of users that include baseline users having particular traits and users that are similar to the baseline users, the method comprising:
identifying baseline users to include in a segment based on a segment rule that specifies a first trait, wherein identifying the baseline users comprises identifying that the baseline users have the first trait based on baseline user data in a user data set, the user data set comprising the baseline user data for the baseline users and other user data for other users;
determining a representation of the segment by evaluating multiple traits of the baseline users using the baseline user data in the user data set;
determining baseline user similarity scores between the baseline users and the representation of the segment with respect to the multiple traits;
determining a similarity threshold based on the baseline user similarity scores;
determining other user similarity scores between the other users and the representation of the segment with respect to the multiple traits; and
identifying a set of the other users to include in the segment based on the other user similarity scores and the similarity threshold.

2. The method of claim 1 further comprising sending electronic communications with customized electronic content to users in the segment.

3. The method of claim 1, wherein determining a representation of the segment comprises determining average values of value-based traits of the multiple traits of the baseline users and determining distribution functions representing non-value-based traits of the multiple traits of the baseline users.

4. The method of claim 3, wherein:
determining the baseline user similarity scores comprises comparing traits of each of the baseline users with the average values or the distribution functions of the representation of the segment; and
determining the other user similarity scores comprises comparing traits of each of the other users with the average values or the distribution functions of the representation of the segment.

5. The method of claim 1, wherein determining the similarity threshold comprises averaging the baseline user similarity scores of all of the baseline users included in the segment.

6. The method of claim 1, wherein determining the other user similarity scores comprises:
determining trait-specific similarity values representing similarities between a respective user and the representation of the segment; and
determining a similarity score for the respective user by combining the trait-specific similarity values.

7. The method of claim 1, wherein combining the trait-specific similarity values comprises combining the trait-specific similarity values according to weights for the multiple traits, the weights determined by determining correlations between the traits.

8. The method of claim 1, wherein combining the trait-specific similarity values comprises combining the trait-specific similarity values based on weights for the multiple traits, the weights determined based on trait variations.

9. The method of claim 1, wherein combining the trait-specific similarity values comprises combining the trait-specific similarity values according to weights for the multiple traits, the weights determined based on a single value decomposition.

10. The method of claim 1, wherein identifying the set of the other users to include in the segment comprises identifying other users having similarity scores indicating greater similarity to segment than an average similarity of the baseline users.

11. A system for creating segments of users that include baseline users having particular traits and users that are similar to the baseline users, the system comprising:
a baseline user identification module for including baseline users in a segment based on a segment rule that specifies a first trait;
a segment analyzing module for determining a representation of the segment by evaluating multiple traits of the baseline users using baseline user data in a user data set;
a user scoring module for determining similarity scores of baseline users and other users based on similarities to the representation of the segment; and
a segment extending module for identifying a set of the other users to include in the segment based on the similarity scores of the baseline users and the other users.

12. The system of claim 11, wherein the user scoring module is configured to:
determine baseline user similarity scores between the baseline users and the representation of the segment with respect to the multiple traits; and
determine other user similarity scores between the other users and the representation of the segment with respect to the multiple traits.

13. The system of claim 11, wherein the segment extending module is configured to identify the set of other users based on a similarity threshold determined using the similarity scores of the baseline users.

14. The system of claim 11, wherein the segment analyzing module is configured to determine the representation of the segment by determining average values of value-based traits of the multiple traits of the baseline users and determining distribution functions representing non-value-based traits of the multiple traits of the baseline users.

15. The system of claim 14, wherein the user scoring module is configured to
determine baseline user similarity scores by comparing traits of each of the baseline users with the average values or the distribution functions of the representation of the segment; and
determine other user similarity scores comprises comparing traits of each of the other users with the average values or the distribution functions of the representation of the segment.

16. The system of claim 11, wherein the user scoring module is configured to determine trait-specific similarity values representing similarities between a respective user and the representation of the segment and determine a similarity score for the respective user by combining the trait-specific similarity values.

17. The system of claim 16, wherein the user scoring module is configured to combined the trait-specific similarity values based on weights determined based on trait correlation or trait variation.

18. A non-transitory computer-readable medium storing instructions, the instructions comprising instructions for:
identifying baseline users to include in a segment based on a segment rule that specifies a first trait, wherein identifying the baseline users comprises identifying that the baseline users have the first trait based on baseline user data in a user data set, the user data set comprising the baseline user data for the baseline users and other user data for other users;
determining a representation of the segment by evaluating multiple traits of the baseline users in the user data set;
determining similarity scores of the baseline users and the other users based on similarities to the representation of the segment; and
identifying a set of the other users to include in the segment based on the similarity scores of the baseline users and the other users.

19. The non-transitory computer-readable medium of claim 18, wherein determining the representation of this segment comprises determining average values of value-based traits of the multiple traits of the baseline users and determining distribution functions representing non-value-based traits of the multiple traits of the baseline users, wherein the similarity scores are determined by comparing traits of the baseline users and the other users with the average values of the distribution functions of the representation.

20. The non-transitory computer-readable medium of claim 18, wherein determining the similarity scores comprises combining trait-specific similarity values determined for the baseline users and other users based on weights determined based on trait correlation or trait variation.
